(19) United States
(12) Patent Application Publication
(10) Pub. No.: US 2014/0145667 A1
(43) Pub. Date: May 29, 2014

(54) RESIN-ENCAPSULATED CURRENT LIMITING REACTOR

(71) Applicant: Aleksandar B. Damjanovic, Oldsmar, FL (US)

(72) Inventor: Aleksandar B. Damjanovic, Oldsmar, FL (US)

(73) Assignee: PHASETRONICS, INC., Clearwater, FL (US)

(21) Appl. No.: 13/688,524

(22) Filed: Nov. 29, 2012

(51) Int. Cl. H01F 5/06; H01F 41/12; H02P 1/02

(52) U.S. Cl. CPC H01F 5/06; H02P 1/02; H01F 41/127
USPC 318/778; 336/222; 29/605

(57) ABSTRACT

The present invention is a resin-encapsulated current limiting reactor that has a number of layers of insulated copper with terminals on each end, and a number of layers of Nomex® fiber insulation wrapped adjacent to each other into a circular or elliptical shape, and encapsulated in polyurethane resin under vacuum.

### CLAIM OF PRIORITY

This application is a continuation in part and claims the benefit of priority of co-pending U.S. Non-Provisional patent application Ser. No. 13/455,947, filed on Apr. 25, 2012.

### FIELD OF THE INVENTION

The present invention relates to current limiting reactors, and in particular, to an improved current limiting reactor with space saving dielectric properties for use in medium voltage soft starters for induction motors.

### BACKGROUND

The starting of induction motors is a process that can damage and influence characteristics and performances of the motor, including its loads and electrical power systems. A significantly higher starting current than the rated current may create mechanical and thermal stress on the motor and the loads. Large voltage fluctuations, such as dips and sags, may occur in the electrical power system associated with the motor.

The invention disclosed in the present inventor's co-pending application Ser. No. 13/455,947 is a soft starter used for smooth starting of medium voltage motors. During the transient process, the “on” and “off” soft current rise, di/dt, may damage the Silicon Controlled Rectifiers (hereinafter, “SCRs”) as it passes them. This is because of the presence of capacitance, especially capacitance of connection cables. A reactor, such as that disclosed in the inventor's co-pending application, may be used to limit the di/dt to a safe level for the SCRs' operation. Although application Ser. No. 13/455,947 is successful in limiting di/dt, there is still a need for a reactor to be able to withstand high voltage requirements, while not taking up too much physical space so as to be able to be installed with switchgear.

Certain prior art has attempt to address the issue, but does not succeed where the present invention has. U.S. Pat. No. 7,330,096 to Shah, for example discloses a fault limiting reactor. This fault limiting reactor would require a great deal of space in order to withstand high voltage levels. As such, it could not be mounted in indoor metal clad switchgear or motor control centers. U.S. Pat. No. 4,462,017 to Knapp, discloses a high voltage air core reactor. This high voltage air core reactor is a standalone reactor that cannot be used to support any other equipment and also cannot be mounted in switchgear or motor control centers. U.S. Pat. No. 5,109,209 to Murison, discloses a current limiting electrical reactor. This current limiting electrical reactor cannot be used in medium voltage soft starters for several reasons. First, the reactor does not satisfy dielectric requirements for the motor control centers and medium voltage switchgear. Second, the reactor cannot be mounted in a space limited environment for use as support for heat sinks of SCRs. U.S. Pat. No. 3,264,590 to Trench, discloses a current limiting reactor. This current limiting reactor is built for outdoor applications and requires a great deal of space. Finally, U.S. Pat. No. 3,057,329 to McConnell, discloses a fault-current limiter for high power electrical transmission systems. This is a complex current limiting device that requires a tremendous amount of space. In addition, it cannot be used for current limiting of fast transients, such as the one experienced with medium voltage soft starters. Therefore there is a continuing need for small reactors that can withstand high voltage peaks in a small amount of space.

### SUMMARY OF THE INVENTION

The present invention includes a resin-encapsulated current limiting reactor, an induction motor soft starter, an induction motor kit, and a method for creating a resin-encapsulated current limiting reactor.

The disclosure of the inventor's co-pending application Ser. No. 13/455,947 for a current limiting reactor for solid state medium voltage soft starters is hereby incorporated by reference.

In its most basic form, the resin-encapsulated reactor of the present invention includes a number of layers of an insulated conductor that has first and second terminals at either end of the conductor and a number of layers of an interlayer insulation wrapped around one another so that they alternate layers, where the layers are encapsulated in resin under vacuum.

The windings may be of any shape, but are preferably circular or elliptical. The term “round” used herein refers to both circular and elliptical shapes. The conductor used in the insulated conductor is preferably copper, aluminum, or a combination of copper and aluminum.

The preferred interlayer insulation is a meta-aramid fiber insulation and the terms “meta-aramid fiber insulation” and “interlayer insulation” are used interchangeably herein. However, it is understood that any interlayer insulation that is compatible with polyurethane resin and is capable of insulating the layers of each windings to the specifications set forth herein may be used. The meta-aramid fiber insulation is preferably poly(m-phenylene isophthalamide) fiber insulation, commonly sold under the trademark Nomex® by E. I. du Pont de Nemours and Company of Wilmington, Del. Hereinafter, the term “Nomex® fiber insulation” refers to poly(m-phenylene isophthalamide) fiber insulation.

The resin used to encapsulate the windings is preferably polyurethane resin. The windings are preferably two or three single or multiple coils connected in parallel. The multilayer technology described herein provides the required inductance of the reactor, which is preferably in the range of 50-200 μH, but may be lower than 50 μH or higher than 200 μH.

The layers of windings are preferably held together with bindings. The bindings are preferably tape, but may be any type of binding, such as electrical tape or Nomex® fiber tape, which will not affect the dielectric, thermal, and mechanical characteristics of the resin-encapsulation.

The first terminal of the insulated conductor is positioned at the beginning of the innermost turn of the windings. The second terminal of the insulated conductor is positioned at the end of the outermost turn of the windings. Both terminals are adapted for electrical connection. The terminals may be any art-recognized electrical connection terminals commonly used in the industry.

Once the windings are appropriately compiled, the windings are encapsulated in resin in order to create the reactor of the present invention. There are two main embodiments of the reactor: plastic molded case and mold casted. In either case, the windings are placed in a mold or plastic molded case and encapsulated in resin under vacuum. Because of this operation under vacuum, the resin-encapsulation fills all voids in the windings. Any gaps or separations between the layers of insulated copper and Nomex® fiber insulation will be filled by the resin. This creates superior mechanical support for reactor, which will be subjected to radial and tangential forces during the start of the motor. The resin-encapsulation also prevents deformation of the coil during the starting of the motor and increases the radial compressive strength of the reactor coil. The movement of the coils during motor starting conditions is therefore greatly suppressed. In addition, the resin-encapsulation prevents moisture penetration into windings. This prevents flashovers due to moisture condensation within windings.

After the resin-encapsulation under vacuum, the curing process takes approximately 24 hours. After this time, with the mold casted reactor, the mold is removed. The result is a mold casted reactor that will be attached to a housing. The housing is not integral to the mold casted reactor. With the plastic molded case reactor, the plastic molded case becomes part of the reactor, so nothing is removed after curing. The result is a plastic molded case reactor. This plastic molded case reactor is preferably used to support heat sinks for SCRs, such as the SCR/heat sink assembly of the soft starter of the present invention.

The resin used for encapsulation is preferably polyurethane resin. Other resins may be substituted, such as epoxy resin or other resins meeting the qualifications described below. The mechanical support that the resin provides, as described above, must be accompanied by a sufficient expansion coefficient so that the resin-encapsulation will not crack or otherwise break under the strain of the motor starting. In addition to the increased mechanical and radial compressive structural support provided by the use of the resin, the resin must also have certain thermal and dielectric characteristics. The resin-encapsulation must increase the mass of the reactor such that the thermal time constant is increased compared to a reactor that does not include resin-encapsulation. The higher thermal time constant must be sufficient to withstand the let-through energy released into the coil during the motor starting. The resin-encapsulated reactor must also withstand the magnetic field effects of the reduction of the cross section of windings, such as skin and proximity effects. Finally, and most importantly, the reactor must have certain dielectric characteristics that increase the inner and outer dielectric strength of the reactor. The triple insulation combination of the insulation on the copper conductors, the interlayer insulation, and the resin-encapsulation must be able to withstand continuous voltage operation up to 15 kV and/or frequency of 50 or 60 Hz.

Polyurethane resin is preferred because it meets all of the above requirements. Any resins to be substituted for polyurethane resin in the present application must have a minimum tensile strength of 2184 psi; must have minimum 3.8% elongation; must have minimum flex modulus of 109,900 psi; must have minimum dielectric strength of 10 kV/mm; must have minimum volume resistivity of 7.5 E 17 Ohm·cm; and must allow the reactor to withstand continuous 15 kV voltage and frequency of 50 or 60 Hz.

The reactor of the present invention is preferably no larger than 9 inches by 15 inches by 15 inches, which is very small for this type of reactor. At the same time, the reactor of the present invention is dielectrically, thermally, and mechanically stronger than its non-resin-encapsulated counterparts. As mentioned above, the resin-encapsulated reactor of the present invention can withstand continuous voltage of 15 kV while taking up no more physical space than 9 inches by 15 inches by 15 inches. The non-resin-encapsulated reactor counterpart would need at least 5 inches more in each dimension so as to safely dissipate the electrical field created in the reactor during motor starting. The smaller space requirements of the resin-encapsulated reactor of the present invention allow it to be installed as a part of the switchgear. This makes installation easy and increases accessibility to the soft starter and the switchgear. The mechanical and thermal capability of resin-encapsulated reactor allow it to withstand 3.5 times the rated current of the induction motor for back-to-back switching periods of time, which are a maximum of 60 seconds. In short, not only is the resin-encapsulated reactor of the present invention smaller, capable of withstanding higher voltage and heat spikes, and able to be installed in the switchgear, but its inclusion within a soft starter makes the soft starter generally stronger and more reliable.

The induction motor soft starter of the present invention is similar to the soft starter of the inventor's co-pending application Ser. No. 13/455,947, except that the current limiting reactor included in the soft starter configuration is a resin-encapsulated current limiting reactor of the present invention, as described above.

The induction motor kit of the present invention is similar to the induction motor kit of the inventor's co-pending application Ser. No. 13/455,947, except that the current limiting reactor included in the soft starter configuration with which the induction motor is in electrical communication is a resin-encapsulated current limiting reactor of the present invention, as described above.

In its most basic form, the method for creating a resin-encapsulated current limiting reactor includes the steps of winding layers of insulated conductor with terminals on each end of the conductor and an interlayer insulation around one another and encapsulating the windings of the layers of insulated conductor and interlayer insulation in a resin under vacuum.

In the preferred embodiment of the method, the said step of winding layers also includes the step of binding the layers together, so as to maintain a shape of the layers wound together.

In embodiments of the method use to manufacture a mold casted reactor, the encapsulating step includes the steps of placing the windings of the layers in a mold, pouring liquid resin into the mold, placing the mold under vacuum such that the liquid resin fills any voids between the windings of the layers, curing the mold to form a resin encapsulated reactor, and removing the resin encapsulated reactor from the mold. This embodiment of the method also includes the step of attaching a housing to the resin encapsulated reactor.

In embodiments of the method use to manufacture a plastic molded case reactor, the encapsulating step includes the steps of placing the windings of the layers in a molded plastic case, pouring liquid resin into the molded plastic case, placing the molded plastic case under vacuum such that the liquid resin fills any voids between the windings of the layers, and curing the resin to form a resin encapsulated reactor in which the molded plastic case is an integrated housing.

In preferred embodiments the winding step involves winding insulated copper, aluminum, or a combination of copper and aluminum with interlayers of Nomex® fiber into either a circular or elliptical shape, and binding the windings together to maintain their shape. In preferred embodiments, the encapsulating step involves encapsulating the windings of the layers of insulated conductor and meta-aramid conductor in polyurethane resin; placing the windings in a mold; and curing the windings within the mold. The method also preferably also includes the step of preparing the terminals of the conductor. With mold casted conductors, this step involves soldering the conductor terminals. With plastic molded case reactors, this step involves applying specialized terminals appropriate for the specific application for which the reactor will be used. Therefore it is an aspect of the present invention to provide a reactor that is mechanically, thermally, and dielectrically far stronger than prior art non-resin-encapsulated reactors.

It is a further aspect of the present invention to provide a reactor that is small enough to be installed in switchgear.

It is a further aspect of the present invention to provide a reactor that can continuously operate at 15 kV, or 50 Hz or 60 Hz.

It is a further aspect of the present invention to provide a reactor including insulated conductor layers wrapped together with Nomex® fiber insulation interlayers and encapsulated in polyurethane resin under vacuum.

It is a further aspect of the present invention to provide a soft starter including the resin-encapsulated reactor of the present invention.

It is a further aspect of the present invention to provide an induction motor kit including an induction motor in electrical communication with a soft starter including the resin-encapsulated reactor of the present invention.

It is a further aspect of the present invention to provide a method for creating the resin-encapsulated reactor of the present invention.

These aspects of the present invention are not meant to be exclusive and other features, aspects, and advantages of the present invention will be readily apparent to those of ordinary skill in the art when read in conjunction with the following description and accompanying drawings.

### BRIEF DESCRIPTION OF THE DRAWINGS

FIG. 1A is a perspective view of circular windings of the present invention before resin-encapsulation.

FIG. 1B is a perspective view of elliptical windings of the present invention before resin-encapsulation.

FIG. 2A is a cutaway diagram of a mold casted reactor of the present invention.

FIG. 2B is an alternate cutaway diagram of a mold casted reactor shown in FIG. 2A.

FIG. 2C is a bottom up diagram of the mold casted reactor shown in FIG. 2A.

FIG. 3A is a perspective view of a mold casted reactor of the present invention in a housing.

FIGS. 3B-3E are various side views of the mold casted reactor shown in FIG. 3A.

FIG. 4A is a perspective view of a plastic molded reactor of the present invention.

FIG. 4B is a cutaway view of the plastic molded reactor shown in FIG. 4A.

FIG. 5A is a diagram of a medium voltage solid state starter including anti-parallel SCRs and the resin-encapsulated current limiting reactor of the present invention before the SCRs.

FIG. 5B is a diagram of a medium voltage solid state starter including anti-parallel SCRs and the resin-encapsulated current limiting reactor of the present invention after the SCRs.

FIG. 6 is a photograph of a preferred soft starter of the present invention.

FIG. 7 is a flow chart showing the steps of the method of the present invention.

### DETAILED DESCRIPTION

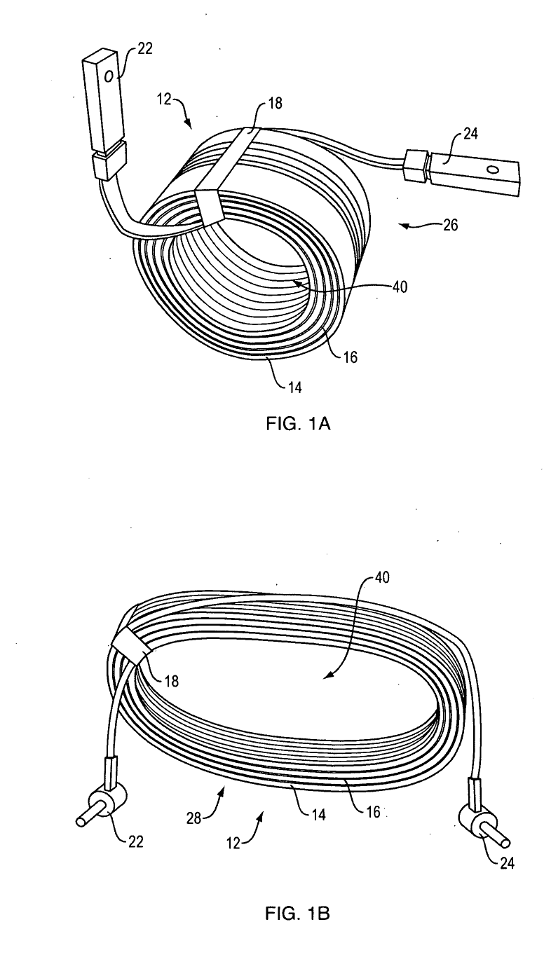

Referring first to FIGS. 1A-1B, windings 12 are shown before resin-encapsulation. FIG. 1A shows circular 26 windings. FIG. 1B shows elliptical 28 windings. In each, the preferred layers of copper insulated conductors 14 are visible alternating with layers of interlayer insulation 16. It is understood that copper insulated conductors 14 may be substituted by other conductors, such as aluminum, or a combination of aluminum and copper. Moreover, the cross sections of the conductors within the insulated conductors 14, which are not visible in these views, may have cross sections of any shape, but are preferably round, square, or rectangular. The insulation around the conductors may be any art-recognized insulator commonly used for insulating conductors, such as plastic or PVC. Finally, although the preferred interlayer insulation 16 is Nomex® fiber, Nomex® fiber may be substituted by any meta-aramid with similar heat resistance and strength characteristics. Windings 12 are preferably two or three single or multiple coils connected in parallel. The multilayer technology described herein provides the required inductance of reactor 10, which is preferably in the range of 50-200 μH. The total length of conductors 14 and the number of layers in windings 12 will depend on the required inductance of reactor 10, which is a function of its application.

As shown in FIGS. 1A and 1B, the layers of windings 12 are held together with bindings 18. Bindings 18 are preferably tape, as shown, but may be any type of binding, such as electrical tape or Nomex® fiber tape, which will not affect the dielectric, thermal, and mechanical characteristics of the resin-encapsulation. First 22 and second 24 terminals are seen extending from windings 12. First terminal 22 is positioned at the beginning of the innermost turn of windings 12. Second terminal 24 is positioned at the end of the outermost turn of windings 12. Both terminals 22, 24 are adapted for electrical connection. Terminals 22, 24 may be any art-recognized electrical connection terminals commonly used in the industry. The different terminals shown in FIGS. 1A and 1B are but two examples. It is preferred that circular 26 windings 12 that are preferably used in mold casted 33 reactors 10, as discussed in more detail below, have soldered copper terminals 22, 24. It is preferred that elliptical 28 windings 12 that are preferably used in plastic molded case 30 reactors 10, also discussed in more detail below, have terminals 22, 24 specialized for the specific application of the reactor 10. The reactor 10 configuration provides an electrical path along the insulated copper conductors 14 between first and second terminals 22, 24 having a current limiting reactance.

Once windings 12 are appropriately compiled, windings 12 are encapsulated in resin in order to create reactor 10 of the present invention. There are two main embodiments of reactor 10: plastic molded case 30 and mold casted 33. The windings 12 are placed in a mold and encapsulated in resin 20 under vacuum. Because of this operation under vacuum, the resin-encapsulation 20 fills all voids in the windings 12. Any cracks or separations between the layers of insulated copper 14 and interlayer insulation 16 will be filled by the resin. This creates great mechanical support for reactor 10. The reactor 10 will exhibit radial and tangential forces during the start of the motor. The resin-encapsulation 20 also prevents deformation of the coil during the starting of the motor and increases the radial compressive strength of the reactor coil. The movement of the coils during motor starting conditions is therefore greatly suppressed. In addition, the resin-encapsulation 20 prevents moisture penetration into windings 12. This prevents flashovers due to moisture condensation within windings 12.

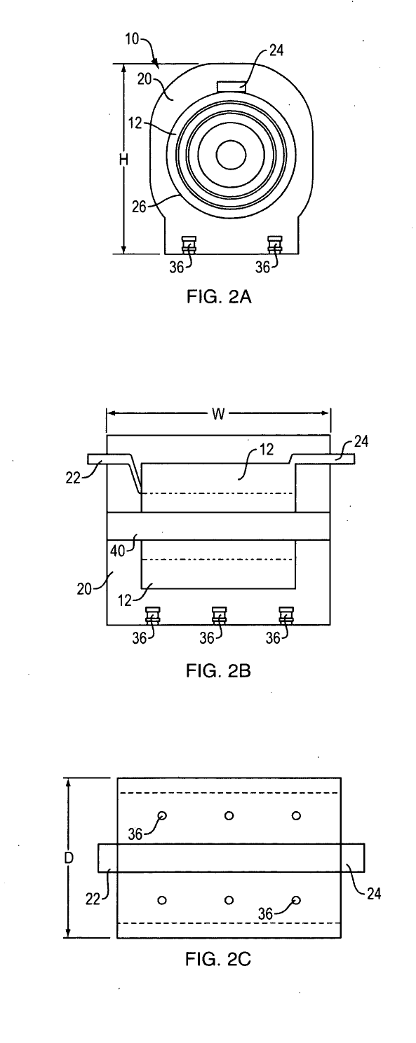

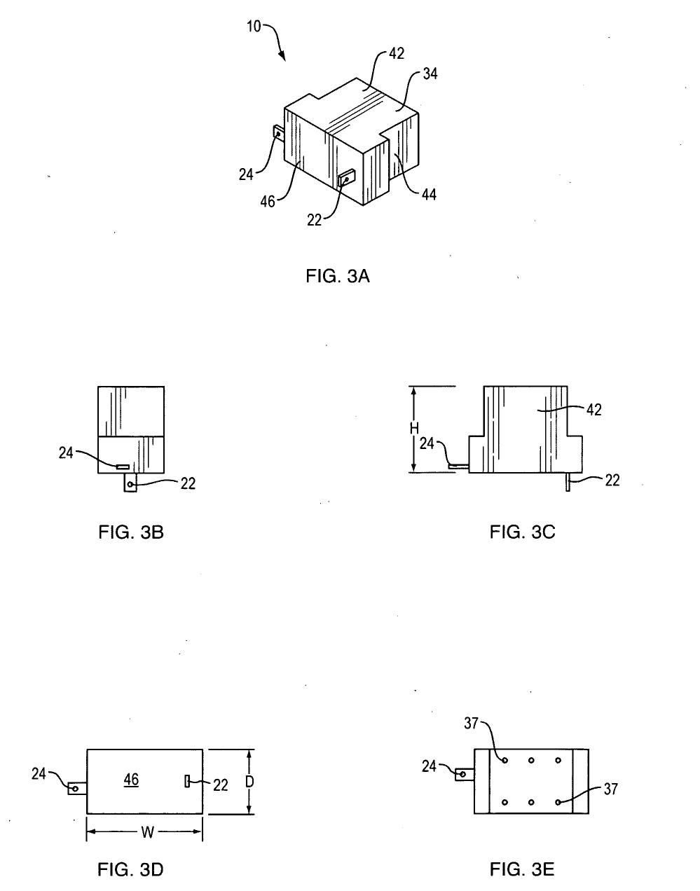

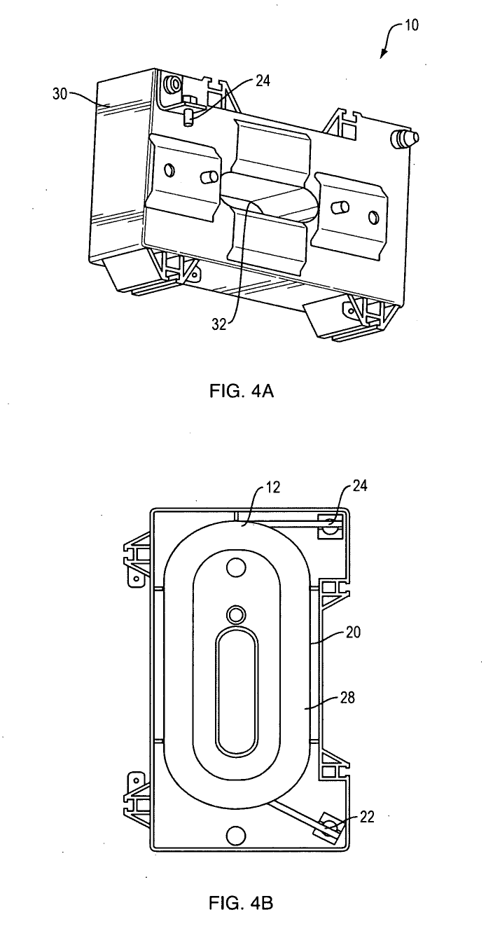

After the resin-encapsulation 20 under vacuum, the curing process takes approximately 24 hours. After this time, with the mold casted 33 reactor 10, the mold is removed. The result is a mold casted 33 reactor 10, such as the one described below with reference to FIGS. 2A-2C that will be housed in a housing 34, as described below with reference to FIGS. 3A-3E. Housing 34 is not integral to mold casted 33 reactor 10. With plastic molded case 30 reactor 10, the plastic molded case has become part of the reactor, so nothing is removed after curing. The result is a plastic molded case 30 reactor 10, such as the one described below with reference to FIGS. 4A and 4B. This plastic molded case 30 reactor 10 is preferably understuck and used to support heat sinks for SCRs, such as SCR/heat sink assembly 140, shown in FIG. 6.

The resin used for encapsulation is preferably polyurethane resin. Other resins may be substituted, such as epoxy resin or other resins meeting the qualifications listed below. The mechanical support that the resin provides, as described above, must be accompanied by a sufficient expansion coefficient so that the resin-encapsulation 20 will not crack or otherwise break under the strain of the motor starting. In addition to the increased mechanical and radial compressive structural support provided by the use of the resin, the resin also must have certain thermal and dielectric characteristics. The resin-encapsulation 20 must increase the mass of the reactor 10 such that the thermal time constant is increased compared to a reactor that does not include resin-encapsulation 20. The higher thermal time constant must be sufficient to withstand the let-through energy released into the coil during the motor starting. The resin-encapsulated reactor 10 must also withstand the magnetic field effects of the reduction of the cross section of windings 12, such as skin and proximity effects. Finally, and most importantly, the reactor 10 must have certain dielectric characteristics that tremendously increase inner and outer dielectric strength of the reactor 10. The triple insulation combination of the insulation on the copper conductors 14, the Nomex® fiber interlayer insulation 16, and the resin-encapsulation 20 must be able to withstand continuous voltage of 15 kV or 50 Hz or 60 Hz. Polyurethane resin is preferred because it meets all of the above requirements. Any resins to be substituted for polyurethane resin in the present application must have a minimum tensile strength of 2184 psi; must have minimum 3.8% elongation; must have minimum flex modulus of 109,900 psi; must have minimum dielectric strength of 10 kV/mm; must have minimum volume resistivity of 7.5 E17 Ohm·cm; and must allow the reactor to continuously operate at 15 kV voltage and 50 Hz or 60 Hz frequency.

Now referring to FIGS. 2A-2C, diagrams of an example of a mold casted 33 reactor 10 of the present invention are provided. FIG. 2A shows a cross section of reactor 10. Windings 12 around windings center 40, within resin-encapsulation 20 are shown. FIG. 2A is a view of FIG. 2B from either side. Therefore although the terminal shown in FIG. 2A is labeled as second terminal 24, it could be either terminal depending on whether you are viewing reactor 10 from the right or left of the depiction shown in FIG. 2B. Inserts 36 are molded along with reactor 10 for mounting purposes, described in more detail below with reference to FIG. 3E. FIG. 2B is a cross section of reactor 10 that is a 90° shift from the cross section shown in FIG. 2A. With this view, windings center 40 extends horizontally across the diagram with windings 12 on either side of center 40, and resin-encapsulation 20 surrounding all. First terminal 22 extends to the left, from the innermost turn of windings 12. Second terminal 24 extends to the right, from the outermost turn of windings 12. FIG. 2C is a bottom up view of FIGS. 2A and 2B, in the same orientation as FIG. 2B. The bottoms of inserts 36 that extend upward into reactor 10, as shown in FIGS. 2A and 2B, are shown in two rows of three. The extensions of terminals 22, 24 are also visible on either side. Although the bottoms of inserts 36 and terminals 22, 24 are shown in FIG. 2C two-dimensionally in the same plane, it is understood that terminals 22, 24 are actually disposed above inserts 36, as shown in FIGS. 2A and 2B. Mold casted 33 reactor 10 shown in FIGS. 2A-2C weighs approximately 65 pounds and has height H of 10.14 inches; width W of 11.70 inches; and depth D of 8.50 inches (height H, width W, and depth D are shown in FIGS. 2A, 2B, and 2C, respectively). This is a very compact reactor.

Now referring to FIGS. 3A-3E diagrams of a mold casted 33 reactor 10 of the type shown in FIGS. 2A through 2C with mold casted 33 reactor 10 within housing 34 are provided. FIG. 3A is a perspective view of reactor 10 within housing 34. Terminals 22, 24 extend from housing 34. Although labeled specifically, it is understood that the terminals shown could be either first 22 or second 24, depending on the orientation of windings 12 within housing 34. In addition, it is understood that terminals 22, 24 may extend from housing 34 in different configurations than that shown, depending on the configuration of terminals 22, 24 extending from windings 12 at the time of the encapsulation in resin. The orientation of terminals 22, 24 shown in FIGS. 2A-2C, for example, is an example of a different configuration.

FIGS. 3B-3E are side views of various faces of housing 34, as shown in FIG. 3A. FIG. 3B is a side view of the face opposite from second face 44, shown in FIG. 3A. FIG. 3C is a side view of first face 42. FIG. 3D is a side view of third face 46. FIG. 3E is a side view of the opposite face from third face 46. As such, the hashing shown on either side of the diagram of FIG. 3E indicates that the hashing is farther away from the viewer than the portion in the middle of the diagram. This middle portion includes screws 37. Comparing FIG. 3E with FIG. 2C, it is clear that screws 37 correspond with the preferred orientation of inserts 36. Screws 37 are aligned with inserts 36 while reactor 10 is mounted inside housing 34. Screws 37 are tightened to secure mold casted 33 reactor 10 in place within housing 34. Housing 34 has height H of 11 inches; width W of 15 inches; and depth D of 8.5 inches. As such reactor 10, as shown in FIGS. 2A-2C could be housed within housing 34.

Now referring to FIGS. 4A and 4B, diagrams of plastic molded case 30 reactor 10 are provided. FIG. 4A is a perspective view of the outside of plastic molded case 30. Air channel 38 approximately mimics windings center 40 of encapsulated windings 12 within plastic mold 30. Air channel 38 may be included in the shape of plastic molded case 30 for cooling purposes, but may be eliminated in some embodiments. Terminal 24 extends from the top of plastic mold 30. Again, the labeling of terminals 22, 24 in FIGS. 4A and 4B is arbitrary, as discussed above. As shown in FIG. 4B, it is preferred that windings 12 that are resin-encapsulated within a plastic molded case 30 are elliptical 28. Plastic molded case 30 may be created to accept windings 12 of any shape, however. Plastic molded case 30 reactor 10 preferably includes a base plate (not shown) as a supporting structure. Plastic molded case 30 reactor 10 is preferably an understuck reactor, especially when understuck to SCRs, as shown in FIG. 6. Unlike mold casted 33 reactor 10, as shown in FIGS. 2A-2C, that is then secured within housing 34, as shown in FIGS. 3A-3E, plastic molded case 30 reactor 10 is one integrated piece that does not require a separate housing. Plastic molded case is preferably 14.25×9.25×4.5 inches.

The mold casted 33 reactor 10 described with reference to FIGS. 2A-2C has dimensions of approximately 10×12×9 inches. The housing 34 described with reference to FIGS. 3A-3E that may house such a mold casted 33 reactor 10 has dimensions of approximately 11×15×9 inches. The plastic molded case 30 reactor 10 described with reference to FIG. 4A has dimensions of approximately 14.25×9.25×4.5 inches. The dimensions of reactor 10, whether mold casted 33 or plastic molded case 30, will vary depending on required inductance, voltage level, the application for which the reactor 10 is to be used, and where the reactor 10 is to be positioned. No reactor 10 of the present invention is larger than 9×15×15 inches, however. In addition, the shape of the windings 12 will vary as discussed above. In general, the shape of the windings 12 will be a function of where the reactor 10 is going to be put, rather than what it will be used for. Elliptical 28 windings 12, for example, are preferred for plastic molded case 30 reactors 10 to be used as an understuck reactor in conjunction with heat sinks for SCR's, as shown in FIG. 6.

This smaller size of reactor 10 is of great significance and is a direct result of the inclusion of and characteristics of the encapsulating resin. As mentioned above, the resin-encapsulated reactor 10 of the present invention can withstand voltage spikes of at least 15 kV while taking up no more physical space than 9 inches by 15 inches by 15 inches. The non-resin-encapsulated reactor counterpart to the resin-encapsulated reactor 10 of the present invention would need at least 5 inches more in each dimension so as to safely dissipate the electrical field created in the reactor during motor starting. With the resin-encapsulated reactor 10 of the present invention, however, the corona and discharges are absorbed by the resin-encapsulation. In addition, as discussed above, the resin-encapsulation 20 increases the mass, and therefore the thermal time constant, of the reactor 10 allowing it to withstand heat spikes that would also require more space to safely dissipate with a non-resin-encapsulated reactor. This lack of a need for space allows the resin-encapsulated reactor 10 of the present invention to be installed as a part of the switchgear 142. This makes installation easy and increases accessibility to the soft starter and the switchgear 142. The increased thermal time constant will tend to increase structural stability of the reactor 10 as the reactor 10 will be less likely to be damaged by heat spikes. Mechanical strength is also increased by the lack of space between the layers 14, 16, as every available space is filled with sturdy resin that prevents movement of the windings during motor starting. The mechanical and thermal capability of resin-encapsulated reactor 10 allow it to withstand 3.5 times the rated current of the motor for back-to-back switching periods of time, which are a maximum of 60 seconds. In short, not only is the resin-encapsulated reactor 10 of the present invention smaller, capable of withstanding higher voltage and heat spikes, and able to be installed in the switchgear, but its inclusion within a soft starter makes the soft starter generally stronger and more reliable.

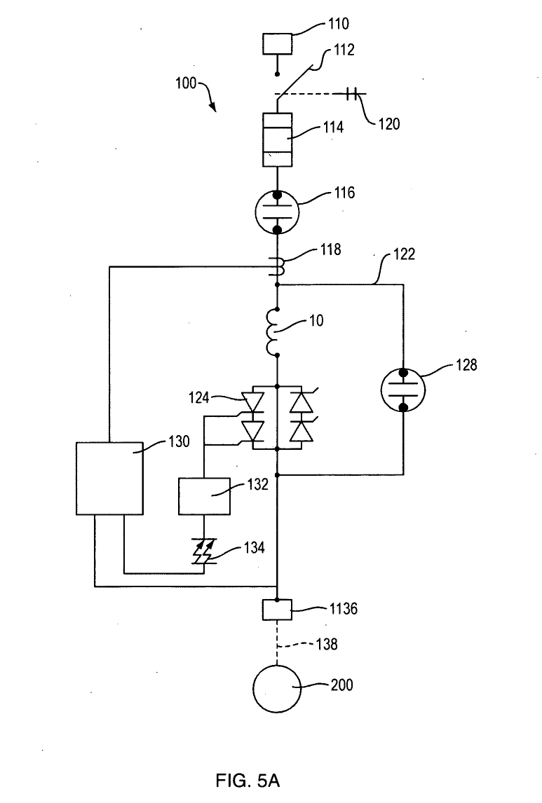

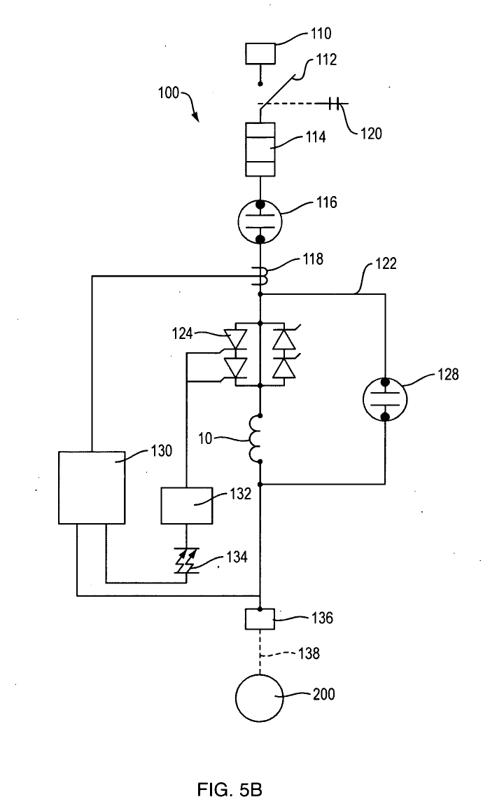

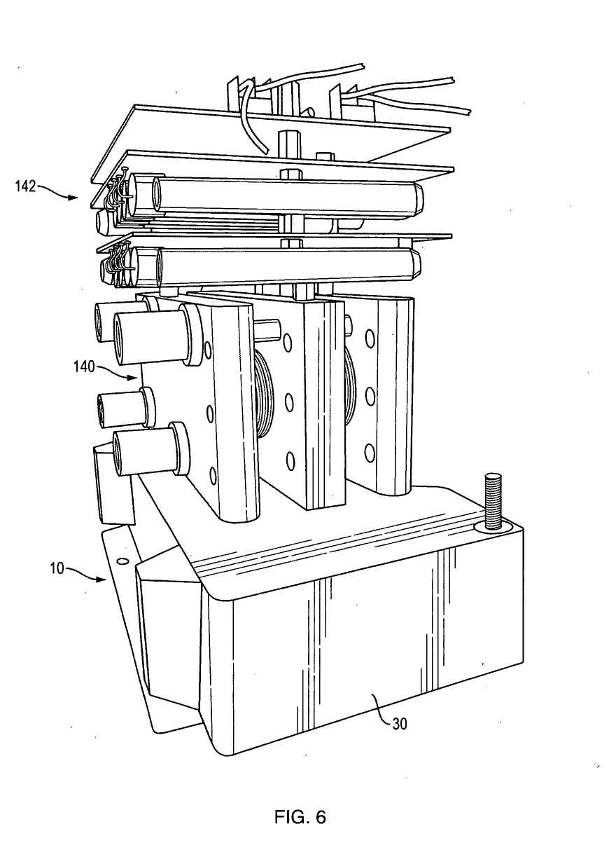

Now referring to FIGS. 5A and 5B, soft starter 100 of the present invention is shown. Soft starter 100 is a medium voltage solid state soft starter, including resin-encapsulated current limiting reactor 10. In particular, soft starter 100 utilizes SCRs 124, bypass contactor 128, line isolation vacuum contactor 116, and motor starter output terminals 136, and is connected to a power system, including power grid 110, power cable 138, and inductance motor 200. Soft starter 100 also includes load break switch 112 with grounding bar 120, motor fuse 114, current transformer 118, low voltage control compartment 130, isolation transformer 132, and fiber optic cable 134. Reactor 10 is disposed within bypass contactor loop 122, either before SCR 124, as shown in FIG. 5A, or after SCR 124, as shown in FIG. 5B. Resin-encapsulated current limiting reactor 10 reduces current rise during the switching on of SCRs 124.

Now referring to FIG. 6, a photograph of a preferred soft starter configuration is shown using understuck plastic molded case 30 reactor 10. From top to bottom, included are switchgear 142, SCR/heat sink assembly 140, and reactor 10 in plastic mold 30. SCR/heat sink assembly 140 includes SCRs 124, discussed above, in combination with heat sinks for absorbing heat from the soft starter's operation. Reactor 10 is understuck to SCR/heat sink assembly 140 to provide mechanical support for this feature.

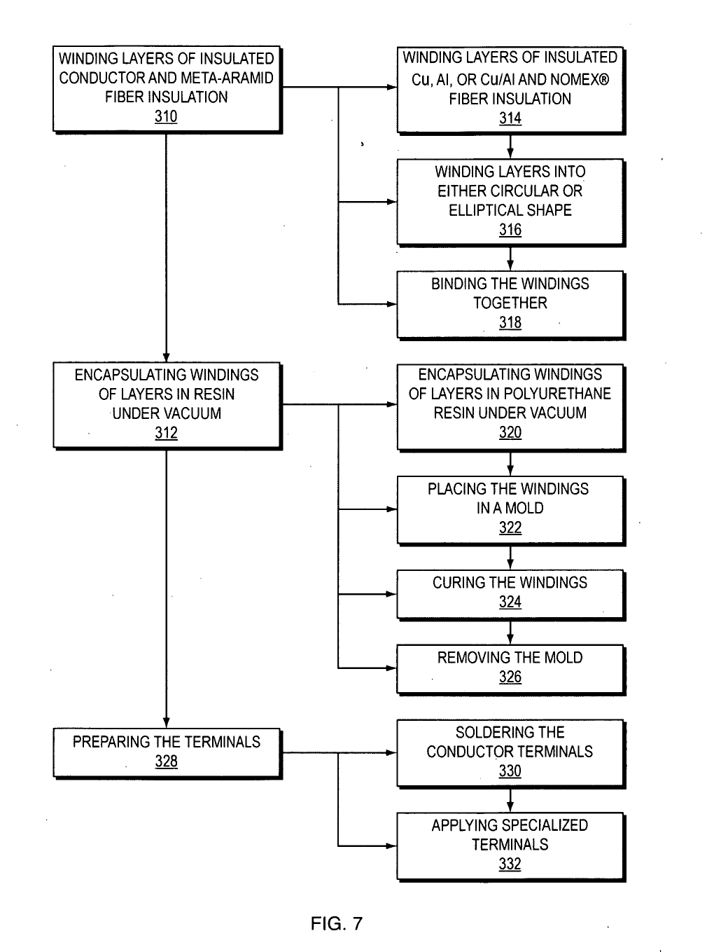

Now referring to FIG. 7, the steps of method 300 for creating a resin-encapsulated current limiting reactor 10 of the present invention are shown. The basic steps of method 300 include winding 310 at least one coil of insulated conductor with terminals on each end of the coil, such that the layers of insulated conductor have an interlayer of meta-aramid fiber insulation between them; and encapsulating 312 the windings of the layers of insulated conductor and meta-aramid conductor in resin under vacuum. The step of winding 310 preferably includes the steps of winding 314 at least one coil of insulated copper, aluminum, or a combination of copper and aluminum with interlayers of Nomex® fiber; winding 316 the layers into either a circular or elliptical shape; and binding 318 the windings together to maintain the shape of the windings. The step of encapsulating 312 preferably includes the steps of encapsulating 320 the windings of the layers of insulated conductor and meta-aramid conductor in polyurethane resin; placing 322 the windings in a mold; curing 324 the windings within the mold; and when the reactor is to be a mold casted reactor, removing 326 the mold. Method 300 preferably also includes the step of preparing 328 the terminals. The step of preparing 328 the terminals preferably either includes soldering 330 the conductor terminals, when the reactor is a mold casted reactor; or applying 332 appropriate specialized terminals, when the reactor is a plastic molded case reactor.

Although the present invention has been described in considerable detail with reference to certain preferred versions thereof, other versions would be readily apparent to those of ordinary skill in the art. Therefore, the spirit and scope of the description should not be limited to the description of the preferred versions contained herein.

What is claimed is:

1. A resin-encapsulated current limiting reactor comprising:
a plurality of layers of an insulated conductor, wherein said insulated conductor comprises a first terminal at a first end of said insulated conductor and a second terminal at a second end of said insulated conductor;
a plurality of layers of interlayer insulation; and
a resin material;
wherein said plurality of layers of said insulated conductor and said plurality of layers of interlayer insulation are wound adjacent to one another into a shape; and
wherein said wound layers of said insulated conductor and said interlayer insulation are encapsulated in said resin such that said resin fills any voids between said plurality of layers of said insulated conductor and said plurality of layers of interlayer insulation.

2. The resin-encapsulated current limiting reactor as claimed in claim 1, wherein said interlayer insulation is a meta-aramid fiber insulation.

3. The resin-encapsulated current limiting reactor as claimed in claim 1, wherein said resin is polyurethane resin.

4. The resin-encapsulated current limiting reactor as claimed in claim 2, wherein:
said meta-aramid fiber insulation is m-phenylene isophthalamide fiber insulation; and
said resin is polyurethane resin.

5. The resin-encapsulated current limiting reactor as claimed in claim 1, wherein said reactor has an inductance between 50 μH and 200 μH.

6. The resin-encapsulated current limiting reactor as claimed in claim 1, wherein said reactor has a maximum overall physical dimension of 9 inches by 15 inches by 15 inches.

7. The resin-encapsulated current limiting reactor as claimed in claim 1, wherein said reactor is capable of withstanding a rated voltage of 15 kV.

8. The resin-encapsulated current limiting reactor as claimed in claim 1, wherein said reactor comprises:
a minimum tensile strength of 2184 psi;
a minimum 3.8% elongation; a minimum flex modulus of 109,900 psi;
a minimum dielectric strength of 10 kV/mm; and
a minimum volume resistivity of 7.5 E17 Ohm·cm.

9. The resin-encapsulated current limiting reactor as claimed in claim 1, further comprising a housing and wherein said resin material is in contact with said housing.

10. The resin-encapsulated current limiting reactor as claimed in claim 9, wherein said reactor comprises at least one insert encapsulated within said resin material and at least one screw extending through said housing and mating with said insert.

11. The resin-encapsulated current limiting reactor as claimed in claim 9, wherein said housing is a molded plastic case that is sized and dimensioned to form a mold within which said resin material is poured during an encapsulation process.

12. The resin-encapsulated current limiting reactor as claimed in claim 1, wherein said molded plastic case comprises an air channel disposed therethrough.

13. An inductance motor soft starter comprising:
a bypass contactor loop on which is disposed at least one SCR; and
a resin-encapsulated current limiting reactor that limits a current rise during a switching on of said at least one SCR, wherein said reactor comprises:
a plurality of layers of an insulated conductor, wherein said insulated conductor comprises a first terminal at a first end of said insulated conductor and a second terminal at a second end of said insulated conductor;
a plurality of layers of interlayer insulation; and
a resin material;
wherein said plurality of layers of said insulated conductor and said plurality of layers of interlayer insulation are wound adjacent to one another into a shape; and
wherein said wound layers of said insulated conductor and said interlayer insulation are encapsulated in said resin such that said resin fills any voids between said plurality of layers of said insulated conductor and said plurality of layers of interlayer insulation.

14. The soft starter as claimed in claim 13, wherein said at least one SCR comprises two anti-parallel connected SCR.

15. The soft starter as claimed in claim 13, further comprising a heat sink;
wherein said heat sink and said SCR form an SCR/heat sink assembly; and
wherein said SCR/heat sink assembly absorbs heat produced by operation of said soft starter.

16. The soft starter as claimed in claim 13, wherein said reactor:
comprises an inductance of between 50 μH and 200 μH;
comprises a maximum overall physical dimension of 9 inches by 15 inches by 15 inches; and
is capable of withstanding a rated voltage of 15 kV.

17. A method for creating a resin-encapsulated current limiting reactor comprising the steps of:
winding layers of insulated conductor with terminals on each end of the conductor and an interlayer insulation around one another; and
encapsulating the windings of the layers of insulated conductor and interlayer insulation in a resin under vacuum.

18. The method as claimed in claim 17, where said step of winding layers further comprises the step of binding the layers together, so as to maintain a shape of the layers wound together.

19. The method as claimed in claim 18;
wherein said encapsulating step comprises the steps of:
placing the windings of the layers in a mold;
pouring liquid resin into the mold;
placing the mold under vacuum such that the liquid resin fills any voids between the windings of the layers.
curing the mold to form a resin encapsulated reactor; and
removing the resin encapsulated reactor from the mold;
wherein said method further comprises the step of attaching a housing to said resin encapsulated reactor.

20. The method as claimed in claim 18;
wherein said encapsulating step comprises the steps of:
placing the windings of the layers in a molded plastic case;
pouring liquid resin into the molded plastic case;
placing the molded plastic case under vacuum such that the liquid resin fills any voids between the windings of the layers; and
curing the resin to form a resin encapsulated reactor in which the molded plastic case is an integrated housing.
